(19) United States
(12) Patent Application Publication
(10) Pub. No.: US 2018/0351894 A1
(43) Pub. Date: Dec. 6, 2018

(54) CHAT TERMINAL DEVICE, CHAT SYSTEM, CHAT DISPLAY METHOD, AND RECORDING MEDIUM

(71) Applicant: JVC KENWOOD Corporation, Yokohama-shi (JP)

(72) Inventors: Hideaki Onoda, Yokohama-shi (JP); Jiro Uzaki, Yokohama-shi (JP)

(21) Appl. No.: 15/933,459

(22) Filed: Mar. 23, 2018

(30) Foreign Application Priority Data
Jun. 5, 2017 (JP) 2017-110948
Jun. 5, 2017 (JP) 2017-110997

(51) Int. Cl. H04L 12/58; G06F 3/0485; G06F 3/0488

(52) U.S. Cl. CPC H04L 51/10; G06F 3/04886; G06F 3/04855; H04L 51/16

(57) ABSTRACT

A chat terminal device includes a communicating unit, a storage unit, and a control unit. The communicating unit obtains pieces of picture data taken of a match and pieces of chat data indicating contents of chat corresponding to the match, from a server into which the pieces of picture data and the pieces of chat data are uploaded. The storage unit stores therein the pieces of picture data and the pieces of chat data obtained by the communicating unit so as to be kept in correspondence with each other by using image taking times at which the pieces of picture data were taken and processed times at which a predetermined process was performed on the pieces of chat data.

### CROSS-REFERENCE TO RELATED APPLICATION(S)

The present application claims priority to and incorporates by reference the entire contents of Japanese Patent Application No. 2017-110948 filed in Japan on Jun. 5, 2017 and Japanese Patent Application No. 2017-110997 filed in Japan on Jun. 5, 2017.

### BACKGROUND

The present invention relates to a chat terminal device, a chat system, a chat display method, and a recording medium.

For matches of sporting events and the like, for example, the status of the matches and the like are reported through a chat function and video pictures taken by cameras are distributed, so that even people who are unable to participate in the matches or unable to directly watch the matches are able to understand the status of the matches. In relation to this, when a user wishes to view the chat texts and the distributed pictures by using a smartphone or the like, it is necessary to switch between the screens for viewing the chat texts and for viewing the pictures. It is therefore difficult to view the chat texts and the pictures at the same time. To cope with this situation, for example, Japanese Patent Application Laid-open No. 2011-91754 A describes recording pictures of a broadcast program and chat texts so as to be temporally kept in correspondence with each other so that, while the broadcast program is being played back, the relevant chat texts are output at the same time.

Although the technique described in Japanese Patent Application Laid-open No. 2011-91754 A makes it possible to view the pictures and the chat texts at the same time in a real-time manner, the technique is not sufficient to enable operations to be performed while utilizing the temporal correspondence between the pictures and the chat texts.

### SUMMARY

A chat terminal device according to one embodiment includes a communicating unit that obtains pieces of picture data taken of a match and pieces of chat data indicating contents of chat corresponding to the match, from a server into which the pieces of picture data and the pieces of chat data are uploaded, a storage unit that stores therein the pieces of picture data and the pieces of chat data obtained by the communicating unit so as to be kept in correspondence with each other by using image taking times at which the pieces of picture data were taken and processed times at which a predetermined process was performed on the pieces of chat data, and a control unit that arranges the pieces of picture data and the pieces of chat data stored in the storage unit to be displayed in mutually-different regions of a display unit and that, when one of the pieces of chat data displayed on the display unit is designated by using an input unit, causes the display unit to display one or more of the pieces of picture data starting from a display start time that is based on the processed time of the designated piece of chat data.

A chat terminal device according to one embodiment includes a communicating unit that obtains pieces of picture data taken of a match and pieces of chat data indicating contents of chat corresponding to the match, from a server into which the pieces of picture data and the pieces of chat data are uploaded, a storage unit that stores therein the pieces of picture data and the pieces of chat data obtained by the communicating unit so as to be kept in correspondence with each other by using image taking times at which the pieces of picture data were taken and processed times at which a predetermined process was performed in relation to the pieces of chat data, and a control unit that arranges the pieces of picture data and the pieces of chat data stored in the storage unit to be displayed in mutually-different regions of a display unit, causes the display unit to display a bar main body of a scroll bar indicating a range of the processed times of the pieces of chat data stored in the storage unit and a slider configured to be movable along the bar main body and indicating the processed time of at least one of the pieces of chat data being displayed on the display unit, and when a position of the slider is changed by using an input unit, causes the display unit to display such one of the pieces of chat data that corresponds to the processed time corresponding to a position of the slider that is after the change.

A chat system includes a server into which pieces of picture data taken of a match and pieces of chat data indicating contents of chat corresponding to the match are uploaded, and a chat display terminal including a communicating unit that obtains the pieces of picture data and the pieces of chat data from the server, a storage unit that stores therein the pieces of picture data and the pieces of chat data obtained by the communicating unit so as to be kept in correspondence with each other by using image taking times at which the pieces of picture data were taken and processed times at which a predetermined process was performed on the pieces of chat data, and a control unit that arranges the pieces of picture data and the pieces of chat data stored in the storage unit to be displayed in mutually-different regions of a display unit and that, when one of the pieces of chat data displayed on the display unit is designated by using an input unit, causes the display unit to display one or more of the pieces of picture data starting from a display start time that is based on the processed time of the designated piece of chat data.

A chat system according to one embodiment includes a server into which pieces of picture data taken of a match and pieces of chat data indicating contents of chat corresponding to the match are uploaded, and a chat display terminal including a communicating unit that obtains the pieces of picture data and the pieces of chat data from the server, a storage unit that stores therein the pieces of picture data and the pieces of chat data obtained by the communicating unit so as to be kept in correspondence with each other by using image taking times at which the pieces of picture data were taken and processed times at which a predetermined process was performed in relation to the pieces of chat data, and a control unit that arranges the pieces of picture data and the pieces of chat data stored in the storage unit to be displayed in mutually-different regions of a display unit, causes the display unit to display a bar main body of a scroll bar indicating a range of the processed times of the pieces of chat data stored in the storage unit and a slider configured to be movable along the bar main body and indicating the processed time of at least one of the pieces of chat data being displayed on the display unit, and when a position of the slider is changed by using an input unit, causes the display unit to display such one of the pieces of chat data that corresponds to the processed time corresponding to a position of the slider that is after the change.

A chat display method according to one embodiment includes obtaining pieces of picture data taken of a match and pieces of chat data indicating contents of chat corresponding to the match, from a server into which the pieces of picture data and the pieces of chat data are uploaded, storing, into a storage unit, the obtained pieces of picture data and pieces of chat data so as to be kept in correspondence with each other by using image taking times at which the pieces of picture data were taken and processed times at which a predetermined process was performed on the pieces of chat data, and arranging the pieces of picture data and the pieces of chat data stored in the storage unit to be displayed in mutually-different regions of a display unit and, when one of the pieces of chat data displayed on the display unit is designated by using an input unit, causing the display unit to display one or more of the pieces of picture data starting from a display start time that is based on the processed time of the designated piece of chat data.

A chat display method according to one embodiment includes obtaining pieces of picture data taken of a match and pieces of chat data indicating contents of chat corresponding to the match, from a server into which the pieces of picture data and the pieces of chat data are uploaded, storing, into a storage unit, the obtained pieces of picture data and pieces of chat data so as to be kept in correspondence with each other by using image taking times at which the pieces of picture data were taken and processed times at which a predetermined process was performed in relation to the pieces of chat data, and arranging the pieces of picture data and the pieces of chat data stored in the storage unit to be displayed in mutually-different regions of a display unit, causing the display unit to display a bar main body of a scroll bar indicating a range of the processed times of the pieces of chat data stored in the storage unit and a slider configured to be movable along the bar main body and indicating the processed time of at least one of the pieces of chat data being displayed on the display unit, and when a position of the slider is changed by using an input unit, causing the display unit to display such one of the pieces of chat data that corresponds to the processed time corresponding to a position of the slider that is after the change.

A recording medium according to one embodiment having recorded thereon a chat display computer program causes a computer to execute processes of obtaining pieces of picture data taken of a match and pieces of chat data indicating contents of chat corresponding to the match, from a server into which the pieces of picture data and the pieces of chat data are uploaded, storing, into a storage unit, the obtained pieces of picture data and pieces of chat data so as to be kept in correspondence with each other by using image taking times at which the pieces of picture data were taken and processed times at which a predetermined process was performed on the pieces of chat data, and arranging the pieces of picture data and the pieces of chat data stored in the storage unit to be displayed in mutually-different regions of a display unit and, when one of the pieces of chat data displayed on the display unit is designated by using an input unit, causing the display unit to display one or more of the pieces of picture data starting from a display start time that is based on the processed time of the designated piece of chat data.

A recording medium according to one embodiment having recorded thereon a chat display computer program causes a computer to execute processes of obtaining pieces of picture data taken of a match and pieces of chat data indicating contents of chat corresponding to the match, from a server into which the pieces of picture data and the pieces of chat data are uploaded, storing, into a storage unit, the obtained pieces of picture data and pieces of chat data so as to be kept in correspondence with each other by using image taking times at which the pieces of picture data were taken and processed times at which a predetermined process was performed in relation to the pieces of chat data, and arranging the pieces of picture data and the pieces of chat data stored in the storage unit to be displayed in mutually-different regions of a display unit, causing the display unit to display a bar main body of a scroll bar indicating a range of the processed times of the pieces of chat data stored in the storage unit and a slider configured to be movable along the bar main body and indicating the processed time of at least one of the pieces of chat data being displayed on the display unit, and when a position of the slider is changed by using an input unit, causing the display unit to display such one of the pieces of chat data that corresponds to the processed time corresponding to a position of the slider that is after the change.

### BRIEF DESCRIPTION OF THE DRAWINGS

FIG. 1 is a block diagram illustrating an example of a chat system according to a first embodiment;

FIG. 2 is a drawing illustrating examples of an input unit and a display unit included in a chat terminal device according to the first embodiment;

FIG. 3 is a drawing illustrating an example of chat data stored in a chat data storage unit;

FIG. 4 is a drawing illustrating an example of synchronization data stored in a synchronization data storage unit;

FIG. 5 is a drawing schematically illustrating a time flow during a match;

FIG. 6 is a drawing illustrating an example of a balloon used for the chat data;

FIG. 7 is a drawing illustrating an example of a situation where a display on the display unit has been changed;

FIG. 8 is a flowchart illustrating an example of operations performed by the chat system according to the first embodiment;

FIG. 9 is a drawing illustrating examples of an input unit and a display unit included in a chat terminal device according to a second embodiment;

FIG. 10 is a drawing illustrating an example of a scroll bar;

FIG. 11 is a drawing illustrating another example of the scroll bar;

FIG. 12 is a drawing illustrating yet another example of the scroll bar;

FIG. 13 is a drawing illustrating yet another example of the scroll bar; and

FIG. 14 is a flowchart illustrating an example of operations performed by a chat system according to the second embodiment.

### DETAILED DESCRIPTION

Exemplary embodiments of a chat terminal device, a chat system, a chat display method, and a chat display computer program according to the present invention will be explained below, with reference to the accompanying drawings. The present invention is not limited by these embodiments. Further, the constituent elements described in the embodiments below include other constituent elements with which substitution by a person skilled in the art is possible and easy, as well as other constituent elements that are substantially the same as those described.

### First Embodiment

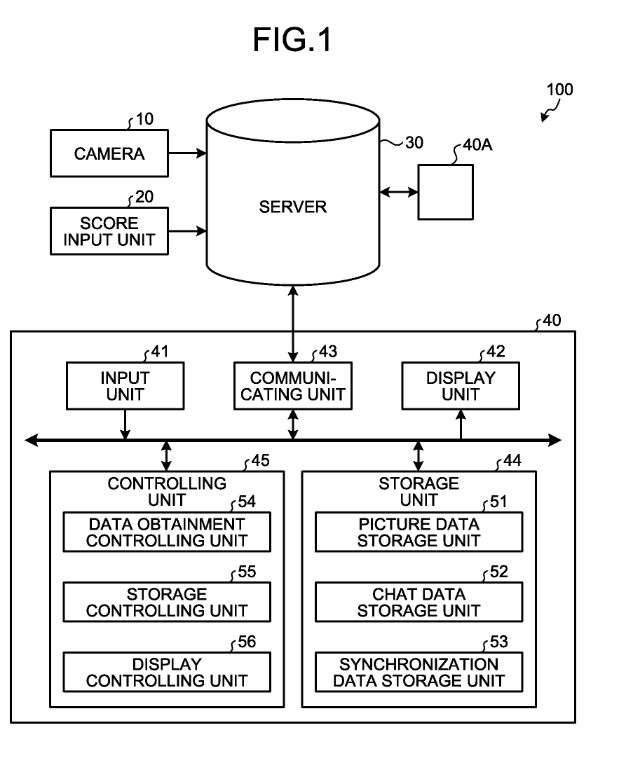

FIG. 1 is a block diagram illustrating an example of a chat system 100 according to a first embodiment. The chat system 100 illustrating in FIG. 1 is used for a sporting event such as baseball, for example, to chat about the contents of a match. By using the chat system 100, it is possible to report the status of the match and the like through a chat function so that, for example, even people who are unable to participate in the match or unable to directly watch the match are able to understand the status of the match. In the following sections, baseball will be used as an example of the sporting event; however, possible embodiments are not limited to this example. The same description is applicable to other sporting events such as soccer, volley ball, tennis, badminton, and the like. Further, the chat system 100 may also be adapted to competitions other than sports such as, for example, dance contests (dancing events), piano competitions (music performance competitions), playing card events (playing card competitions or table game competitions), karaoke events (singing competitions), and the like.

As illustrated in FIG. 1, the chat system 100 includes a camera 10, a score input unit 20, a server 30, and chat terminal devices 40 and 40A. The camera 10 takes pictures of the contents of a match at a match venue, for example. Picture data taken by the camera 10 is transmitted to the server 30, for example, and is managed in the server 30. The camera 10 may be realized with one camera or two or more cameras. Further, as long as the camera 10 is capable of taking the picture data, the camera 10 may be a camera or the like built into a mobile phone, a smartphone, or the like, for example. When having taken the picture data, the camera 10 arranges the picture data to include data indicating image taking times.

The score input unit 20 inputs match status data indicating the status of the match to the server 30. In the first embodiment, as an example of the match status data indicating the status of a baseball match, score data will be used, for example. Pieces of score data are data structuring the score recorded in a baseball scorebook and represent individual events included in a series of events starting with a pitch by a pitcher. The score is a set made up of such pieces of score data. Accordingly, every time a pitcher throws a ball, a plurality of pieces of score data are generated, and one score entry is generated from the pieces of score data. For example, with a runner on first base, when a batting result exhibits that the batter flied out to right field, and the first-base runner was also tagged out, a piece of score data indicating that the batter was out, another piece of score data indicating the fly to right field, and yet another piece of score data indicating that the first-base runner was out are generated. From these pieces of score data, one score entry is generated.

Besides the pieces of score data described above, the score may include pieces of score data indicating actions of batters, actions of fielders, confirmed counts, runners' advances on the bases if there already are one or more runners on the bases, as well as other actions of batters and fielders. More specifically, the score may include pieces of score data indicating strikes, balls, foul balls, batting results, types of batted balls, fielders that caught the ball, and advances on the bases. The batting results are indicated with information such as an out, a one-base hit, a two-base hit, a three-base hit, a home run, and the like. The types of batted balls are indicated with information such as a ground ball, a line drive, a fly, a bunt, and the like, which may further be classified in detail. The fielders who caught the ball are indicated with information specifying the fielders who actually caught a batted ball or the fielding position of each of such fielders. The advances on the bases are indicated with information related to advances of runners on the bases such as “from first base to second base”, for example, and may include other information such as other actions of batters and/or fielders.

The score input unit 20 may be an application or the like that, for example, inputs the score data described above to the server 30 as electronic data. In this situation, the score input unit 20 may be provided in a processing apparatus such as a personal computer installed on the outside of the server 30. Alternatively, the score input unit 20 may be provided in the server 30. In the first embodiment, the score input unit 20 does not necessarily have to be provided.

The server 30 integrally manages the chat system 100. The server 30 has various types of applications, data, computer programs, and the like used for managing the chat system 100. The server 30 may be configured, for example, by using a personal computer, a workstation, or the like, but possible examples are not limited to these.

In the server 30, a plurality of chat groups are set. The chat groups are individually set in correspondence with, for example, sporting events, matches, or teams. For each of the chat groups, the server 30 performs various types of processes described below.

The server 30 receives an input of pieces of picture data taken by the camera 10 and pieces of chat data indicating the contents of chat texts corresponding to the match. The server 30 saves therein the pieces of picture data and the pieces of chat data that were input thereto. As a result of the server 30 saving the pieces of picture data and the pieces of chat data therein, the pieces of picture data and the pieces of chat data have been uploaded in the server 30. When having saved the pieces of chat data therein, the server 30 arranges each of the pieces of chat data to include data indicating the time (hereinafter, an “upload time”) at which the piece of chat data was saved. In other words, each of the pieces of chat data uploaded in the server 30 includes the data indicating the upload time thereof. The server 30 has a managing application that manages the pieces of picture data and the pieces of chat data.

Alternatively, the score data may be input to the server 30 from the score input unit 20. In that situation, the server 30 may generate chat data on the basis of the score data input thereto and save the chat data therein. For example, every time a new piece of score data is input thereto, the server 30 is able to generate a piece of chat data expressing the contents of the piece of score data by using text or the like. As a result, every time any of the pieces of score data is updated, the user is able to view the updated piece of score data, as information in chat.

The chat terminal devices 40 and 40A each include an input unit 41, a display unit 42, a communicating unit 43, a storage unit 44, and a controlling unit 45. The input unit 41, the display unit 42, the communicating unit 43, the storage unit 44, and the controlling unit 45 are connected to one another via a bus line or the like, for example. The chat terminal device 40 may be configured by using a portable information terminal such as, for example, a mobile phone, a smartphone, a tablet, or a notebook personal computer.

On the input unit 41, it is possible to perform predetermined input operations to input information such as the chat data. In accordance with each of the input operations, the input unit 41 outputs an instruction signal to the controlling unit 45. The input unit 41 may be configured by using an input device such as a touch panel, for example. As the input unit 41, a button, a lever, a dial, a switch, or another input device may be used in addition to the touch panel or in place of the touch panel. The input unit 41 outputs the instruction signal corresponding to each of the predetermined input operations. The display unit 42 displays various types of information including texts and images. The display unit 42 includes a display panel such as a liquid crystal panel. The display unit 42 is capable of displaying information including pictures.

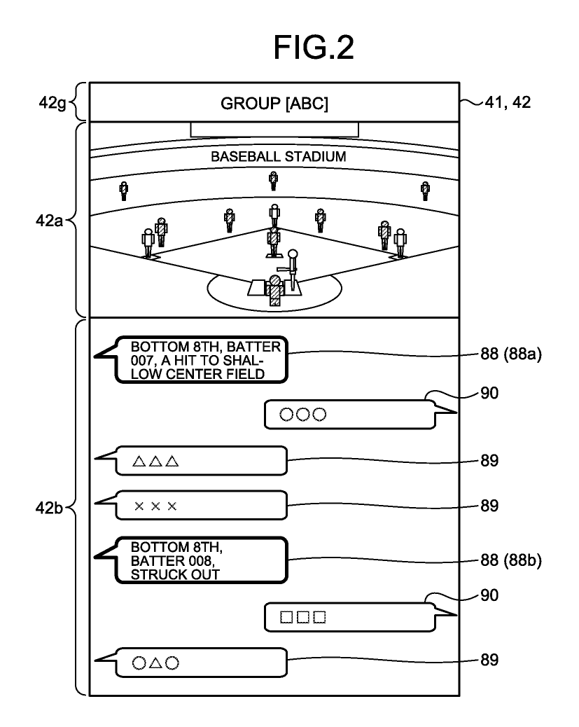

FIG. 2 is a drawing illustrating examples of the input unit 41 and the display unit 42 included in the chat terminal device 40 according to the first embodiment. As illustrated in FIG. 2, the chat terminal device 40 includes the input unit 41 and the display unit 42 that are of a touch panel type, for example. In other words, a touch panel serving as the input unit 41 is arranged to be on top of a display panel serving as the display unit 42.

On the display unit 42, for example, a picture display region 42a, a chat display region 42b, and a group display region 42g are displayed. In the picture display region 42a, picture data can be displayed. In the picture display region 42a, a scroll bar or the like may be displayed for the purpose of designating a playback time of the picture data.

In the chat display region 42b, chat data can be displayed. For example, in the chat display region 42b, server messages 88 each represented by a piece of chat data generated by the server 30, third party messages 89 each represented by a piece of chat data input by the other chat terminal device 40A that is different from the chat terminal device 40, and user's own messages 90 each represented by a piece of chat data input by the chat terminal device 40 can be displayed. The server messages 88, for example, each indicate, by using text, the contents of a piece of score data input to the server 30. The server message 88a on the upper side in FIG. 2 indicates that, for example, batter 007 got a hit to shallow center field in the bottom of the eighth inning. Further, the server message 88b on the lower side of FIG. 2 indicates that batter 008 struck out in the bottom of the eighth inning.

The server messages 88 and the third party messages 89 are, for example, displayed in the region positioned on the left side of the chat display region 42b. Further, the user's own messages 90 are displayed in the region positioned on the right side of the chat display region 42b. In addition, the server messages 88 and the third party messages 89 may be displayed in a distinguished manner, for example, by using mutually-different types of frames in which the messages are displayed. With this arrangement, the viewer is able to distinguish the server messages 88 from the third party messages 89. In the group display region 42g, information about the group to which the operator of the chat terminal device 40 belongs is displayed. Further, the server messages 88, the third party messages 89, and the user's own messages 90 are each displayed within a frame such as a balloon. As the number of characters in each of the balloons increases, for example, the displayed balloon can be expanded in the left-and-right direction and the up-and-down direction within the chat display region 42b.

When an operation such as a touch operation or a scrolling operation is performed in a predetermined region on the surface of the touch panel, the input unit 41 outputs a predetermined instruction signal including position information of the region where the operation was performed and the information of the operation. The position information is, for example, set in correspondence with the position of the display unit 42. Possible configurations of the input unit 41 and the display unit 42 are not limited to the examples described above.

The communicating unit 43 performs information communication with an external device in a wired or wireless manner. For example, the communicating unit 43 transmits and receives the picture data, the chat data, the score data, and the like to and from the server 30 provided on the outside thereof.

The storage unit 44 has a storage device such as, for example, a hard disk drive, a solid state drive, or the like. Alternatively, as the storage unit 44, an external storage medium such as a removable disk may also be used. The storage unit 44 stores therein an operating system of the chat terminal device 40, various types of computer programs for controlling operations of the input unit 41, the display unit 42, and the communicating unit 43, a chat application, various types of computer programs, data, and the like used for communicating through a chat function. For example, the storage unit 44 may store therein frame data or the like of the picture display region 42a, the chat display region 42b, the group display region 42g, and the like displayed on the display unit 42.

Further, the storage unit 44 stores therein a chat display computer program that causes a computer to execute processes of: obtaining the pieces of picture data taken of a match of a sporting event and the pieces of chat data indicating the contents of chat corresponding to the match, from the server into which the pieces of picture data and the pieces of chat data are uploaded; storing the obtained pieces of picture data and pieces of chat data into the storage unit 44, so as to be kept in correspondence with each other by using the image taking times at which the pieces of picture data were taken and processed times at which a predetermined process was performed on the pieces of chat data; arranging the pieces of picture data and the pieces of chat data stored in the storage unit 44 to be displayed in the mutually-different regions of the display unit 42; and when one of the pieces of chat data displayed on the display unit 42 is designated by using the input unit 41, causing the display unit 42 to display one or more of the pieces of picture data starting from a display start time that is based on the processed time of the designated piece of chat data.

Further, the storage unit 44 stores therein a chat display computer program that causes a computer to execute processes of: obtaining the pieces of picture data taken of a match of a sporting event and the pieces of chat data indicating the contents of chat corresponding to the match, from the server into which the pieces of picture data and the pieces of chat data are uploaded; storing the obtained pieces of picture data and pieces of chat data into the storage unit 44, so as to be kept in correspondence with each other by using the image taking times at which the pieces of picture data were taken and the processed times at which a predetermined process was performed on the pieces of chat data; arranging the pieces of picture data and the pieces of chat data stored in the storage unit 44 to be displayed in the mutually-different regions of the display unit 42, while causing the display unit 42 to display a bar main body of a scroll bar that indicates a range of the processed times of the pieces of chat data stored in the storage unit 44 and a slider that is movable along the bar main body and indicates the processed time of at least one of the pieces of chat data being displayed on the display unit 42; and causing the display unit 42 to display, when the position of the slider is changed by using the input unit, such one of the pieces of chat data that corresponds to the processed time corresponding to the position of the slider after the change.

The storage unit 44 includes a picture data storage unit 51, a chat data storage unit 52, and a synchronization data storage unit 53.

The picture data storage unit 51 stores therein the picture data received by the communicating unit 43. The picture data includes pieces of data representing the pictures of the match taken of the baseball match. The pieces of picture data are kept in correspondence with the image taking times at which the pictures of the match were taken. The picture data storage unit 51 is capable of storing therein a plurality of pieces of picture data.

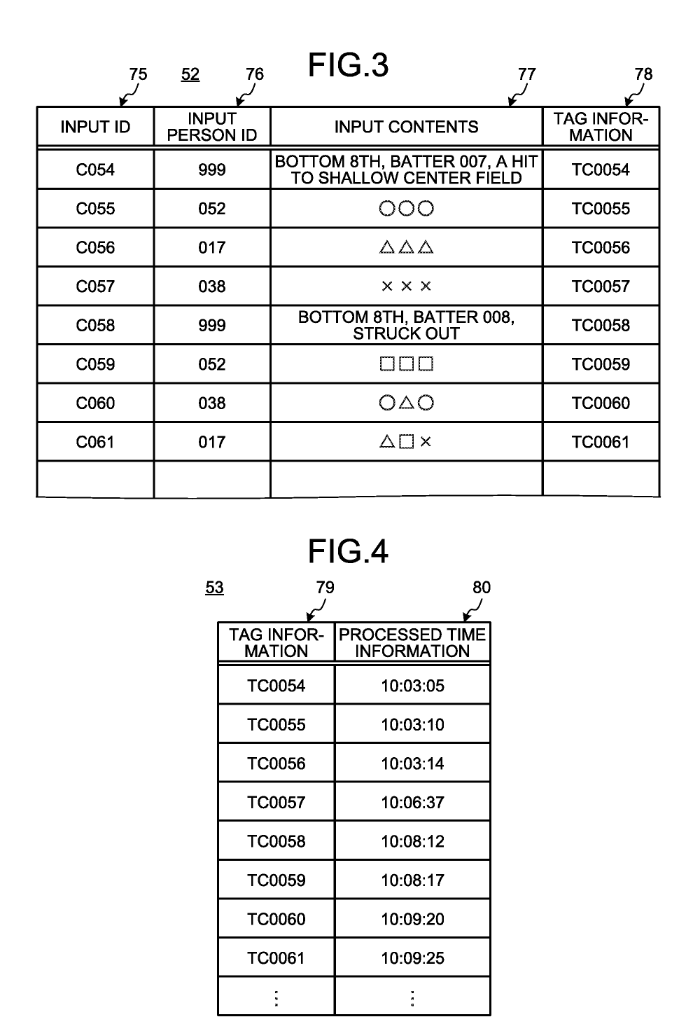

The chat data storage unit 52 stores therein the chat data received by the communicating unit 43. FIG. 3 is a drawing illustrating an example of the chat data stored in the chat data storage unit 52. As illustrated in FIG. 3, the chat data includes input IDs 75, input person IDs 76, input contents 77, and tag information 78.

One input ID 75 is generated every time a piece of chat data is input to or generated by the server 30. The input person IDs 76 are each information identifying the person who input the corresponding piece of chat data. For example, when a piece of chat data is generated by the server 30, the input person ID 76 may be expressed with a predetermined value (e.g., “999”). The input contents 77 are represented by information indicating the contents of the messages displayed in the chat display region 42b. The input contents 77 may include, for example, text data or predetermined illustration data. The tag information 78 is information identifying each of the pieces of chat data generated in correspondence with the input IDs 75. A piece of tag information 78 is generated every time one input ID 75 is generated. To the pieces of tag information 78, tag numbers (TC0054, TC0055, and so on) are assigned in ascending order as indexes. Alternatively, the ID numbers of the input IDs 75 may be used as the tag information.

The synchronization data storage unit 53 stores therein synchronization data that keeps the pieces of score data and the pieces of chat data in correspondence with each other. FIG. 4 is a drawing illustrating an example of the synchronization data stored in the synchronization data storage unit 53. As illustrated in FIG. 4, the synchronization data includes tag information 79 and processed time information 80. The tag information 79 is information corresponding to the tag information 78 of the chat data described above. The pieces of tag information 79 are arranged in an order according to the processed time information 80. To the pieces of tag information 79, the same tag numbers (TC0054, TC0055, . . . , and TC0061) as those assigned to the corresponding pieces of tag information 78 are assigned; however, possible embodiments are not limited to this example. The processed time information 80 is information that is kept in correspondence with the tag information 79 and indicates the processed times of the pieces of chat data. The processed times of the pieces of chat data may each be an upload time at which the corresponding piece of chat data was uploaded into the server 30. Alternatively, the processed times of the pieces of chat data may each be an input start time at which the corresponding piece of chat data started being input. By using the tag information 79 and the processed time information 80, the pieces of picture data and the pieces of chat data are stored while being kept in correspondence with each other, on the basis of the image taking times and the processed times.

The controlling unit 45 controls the functional units such as the input unit 41, the display unit 42, and the communicating unit 43. Further, the controlling unit 45 performs calculations and processing processes in accordance with instruction signals from the input unit 41. The controlling unit 45 includes a processing apparatus such as a Central Processing Unit (CPU) and storage devices such as a Random Access Memory (RAM), a Read-Only Memory (ROM), and/or the like. The controlling unit 45 includes a data obtainment controlling unit 54, a storage controlling unit 55, and a display controlling unit 56.

The data obtainment controlling unit 54 accesses the server 30 via the communicating unit 43 and obtains the pieces of picture data and the pieces of chat data uploaded in the server 30.

The storage controlling unit 55 stores the obtained pieces of picture data and pieces of chat data into the storage unit 44 so as to be kept in correspondence with each other, on the basis of the image taking times and the processed times. For example, the storage controlling unit 55 arranges the pieces of tag information 78 of the obtained pieces of chat data in the chronological order of the processed times to obtain the pieces of tag information 79. The storage controlling unit 55 stores the pieces of processed time information 80 corresponding to the pieces of tag information 79 so as to be kept in correspondence with the obtained pieces of picture data.

The display controlling unit 56 controls the contents of the display displayed on the display unit 42. On the basis of the picture data stored in the storage unit 44, the display controlling unit 56 controls the contents of the display in the picture display region 42a. For example, when a plurality of pieces of picture data are stored in the storage unit 44, the display controlling unit 56 causes one of the pieces of picture data selected by using the input unit or the like to be displayed in the picture display region 42a. As another example, when a scroll bar used for designating a playback time is displayed in the picture display region 42a, the display controlling unit 56 causes pieces of picture data starting from the playback time designated by using the scroll bar to be displayed in the picture display region 42a.

Further, on the basis of the chat data stored in the storage unit 44, the display controlling unit 56 controls the contents of the display in the chat display region 42b. When displaying the chat data in the chat display region 42b, the display controlling unit 56 displays as many pieces of chat data as displayable in the chat display region 42b so that the pieces of chat data are arranged in one direction in a time series on the basis of the upload times thereof. In the first embodiment, as illustrated in FIG. 2 for example, the pieces of chat data are displayed as being arranged in the chat display region 42b in a time series from the top to the bottom of the drawing.

Further, when a new piece of chat data is obtained from the server 30 and stored into the storage unit 44, the display controlling unit 56 updates the contents of the display in the chat display region 42b on the basis of the newest piece of chat data stored in the storage unit 44. In this situation, the display controlling unit 56 judges whether or not the chat display region 42b has a space for arranging the new piece of chat data to be displayed below the piece of chat data displayed chronologically most recently. When there is a space for displaying the new piece of chat data, the display controlling unit 56 causes the new piece of chat data to be displayed in the space. By contrast, when there is no space for displaying the new piece of chat data, the display controlling unit 56 scrolls the entirety of the chat display region 42b in such a direction that the chronologically oldest piece of chat data among the pieces of chat data displayed in the chat display region 42b, i.e., the piece of chat data displayed in the topmost position in the chat display region 42b, is pushed out to the position above the chat display region 42b. After that, the display controlling unit 56 causes the new piece of chat data to be displayed in the space in the lower section that became available due to the scrolling. With this arrangement, the display controlling unit 56 is able to update, in a real-time manner, the chat data displayed in the chat display region 42b, every time a new piece of chat data is uploaded to the server 30 and stored into the storage unit 44.

Further, the display controlling unit 56 is also capable of controlling the contents of the display in the chat display region 42b, on the basis of one or more pieces of chat data from the past stored in the storage unit 44. For example, when the operator keeps touching the chat display region 42b of the input unit (the touch panel) 41 and slides the touch position upward or downward, i.e., when the operator performs an operation to manually scrolling the chat display region 42b, the display controlling unit 56 changes the chat data being displayed in the chat display region 42b, in accordance with the scrolling direction and the scrolling amount. For example, when the operator slides the touch position upward, one or more pieces of chat data that were uploaded later than the pieces of chat data that have so far been displayed will be displayed in the chat display region 42b. By contrast, when the operator slides the touch position downward, one or more pieces of chat data that were uploaded earlier than the pieces of chat data that have so far been displayed will be displayed in the chat display region 42b. Possible methods for changing the chat data being displayed in the chat display region 42b are not limited to the examples described above. For instance, it is also acceptable to use other methods such as those using a button, a keyboard, a mouse, or the like.

Further, in the first embodiment, when one of the pieces of chat data displayed in the chat display region 42b is designated by using the input unit 41, the display controlling unit 56 is capable of causing one or more pieces of picture data to be displayed in the picture display region 42a, starting from the time (a display start time) that is based on the image taking time corresponding to the processed time of the designated piece of chat data.

In that situation, the display controlling unit 56 detects the processed time of the designated piece of chat data from the synchronization data storage unit 53 and sets, as the display start time, a time that is earlier than the detected processed time by a first time period.

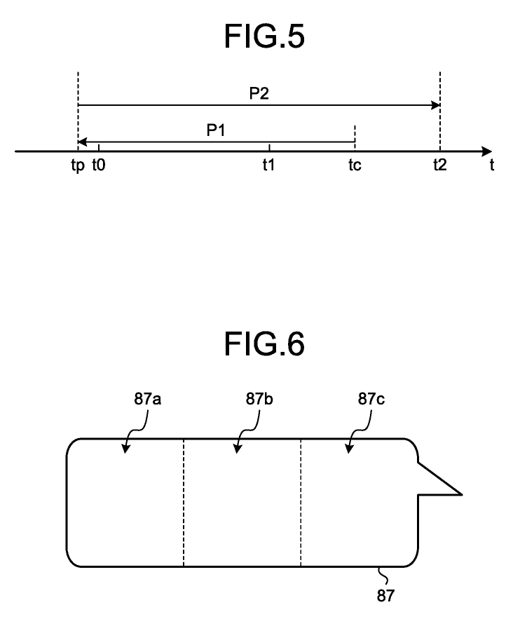

FIG. 5 is a drawing schematically illustrating a time flow during a match. During the match, when there is a batting result such as a one-base hit or a two-base hit, as illustrated in FIG. 5, the batting result is confirmed (the time t1) after the pitcher pitches the ball (the time t0), and the batter hits the ball, runs, and advances to first base, second base, or the like, for example. Accordingly, when a spectator who is watching the match in a real-time manner inputs a batting result such as “got a hit” or “got a two-base hit” as a piece of chat data, the processed time of the piece of chat data is a time (the time tc) later than the time at which the batting result is confirmed.

To cope with this situation, in the first embodiment, by setting a display start time (the time tp) to be earlier than the processed time tc by a first time period P1, the display controlling unit 56 is able to display the display data starting from the time at which a series of scenes related to the batting result begins or starting from a time close to that time. The first time period P1 may be set in advance or may be set by the display controlling unit 56.

For example, the display controlling unit 56 may set the first time period P1 in such a manner that, for example, the larger the volume of the piece of chat data is, the longer is the first time period P1. When the volume of the piece of chat data is larger, i.e., when the number of characters or the like contained in the chat text is larger, it is assumed that it takes longer to input the piece of chat data, and the time period between the confirmation of the batting result and the uploading of the chat text is therefore longer. Accordingly, on the assumption that the larger the volume of the piece of chat data is, the longer time it takes to upload the chat text after the batting result is confirmed, the display controlling unit 56 arranges the first time period P1 to be longer. The length of the first time period in this situation may be changed as appropriate, depending on the type of the sporting event or the like.

Further, another arrangement is also acceptable in which the operator is able to arbitrarily set the first time period P1. For example, when a piece of chat data is designated, the display controlling unit 56 may set the first time period P1 in accordance with the position being touched in the balloon. FIG. 6 is a drawing illustrating an example of the balloon used for the chat data. In the example illustrated in FIG. 6, a balloon 87 is divided into three sections, so as to set a first region 87a positioned on the left side in the drawing, a second region 87b positioned in the middle of the drawing, and a third region 87c positioned on the right side of in the drawing. The display controlling unit 56 may set the first time period P1 to mutually-different lengths of time, in the situation where the operator has touched the first region 87a, in the situation where the operator has touched the second region 87b, and in the situation where the operator has touched the third region 87c. For example, the display controlling unit 56 may set the first time period P1 to be longer in the order of the third region 87c, the second region 87b, and the first region 87a, or conversely, may set the first time period P1 to be shorter in this order.

Further, for example, when the server 30 is configured to generate a piece of chat data on the basis of input score data and to save the generated piece of chat data therein, the time at which the score data is generated or saved is later than the time at which the batting result is confirmed, similarly to the situation described above. To cope with this situation, when setting the display start time, the display controlling unit 56 may detect the processed time of a designated piece of chat data, detect a server message (the piece of chat data generated by the server 30) having the most recent processed time earlier than the detected processed time, and set the processed time of the detected server message as the display start time.

Further, after setting the display start time, the display controlling unit 56 is capable of causing pieces of picture data to be displayed in the picture display region 42a, starting from the display start time until a second time period P2 elapses. For example, the display controlling unit 56 may set, as the second time period P2, a length of time that is sufficient for displaying a series of scenes related to a batting result. Alternatively, as the second time period P2, the display controlling unit 56 may set what is called a picture cuing time period, which is approximately a number of seconds, for example. In this situation, the display controlling unit 56 may set the second time period P2 to a certain length of time in advance, in correspondence with each of different types of sporting events or the like, for example. Further, the display controlling unit 56 may cause one or more pieces of picture data to be displayed in the picture display region 42a even after the second time period P2 has elapsed since the display start time.

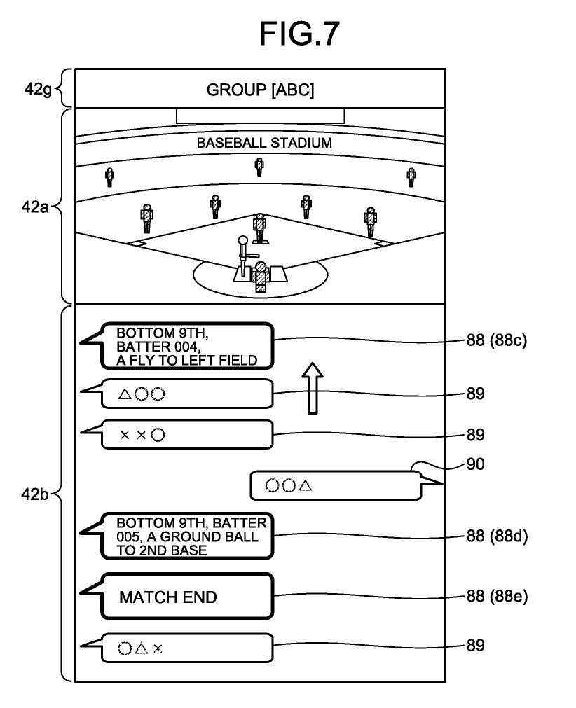

FIG. 7 is a drawing illustrating an example of a situation where the display on the display unit 42 has been changed. FIG. 7 illustrates the situation in which the display in the chat display region 42b has been changed from the state illustrated in FIG. 2 (the bottom of the eighth inning) to the state when the match was over (the bottom of the ninth inning) by scrolling the screen toward the top of the drawing. In that situation, as illustrated in FIG. 7, server messages 88c to 88e are being displayed in the chat display region 42b. The server message 88c is a piece of chat data indicating that, for example, batter 004 flied out to left field in the bottom of the ninth inning. The server message 88d is a piece of chat data indicating that batter 005 hit a ground ball to second base and was out. The server message 88e is a piece of chat data indicating that the match is over.

In this situation, for example, when a piece of chat data such as the server message 88c, any one of the third party messages 89, or the user's own message 90 is designated, one or more pieces of picture data are displayed in the picture display region 42a starting from the display start time that is based on the processed time of the designated piece of chat data. For example, in the example illustrated in FIG. 7, a scene is displayed in which a right-handed batter is standing in the batter's box while there are no runners on the bases.

It is also possible to return the picture display region 42a from the state illustrated in FIG. 7 to the state illustrated in FIG. 2, by scrolling the display in the chat display region 42b toward the bottom of the drawing so as to cause the situation illustrated in FIG. 2 to be displayed and further designating the piece of chat data illustrated in FIG. 2 again. In this manner, by displaying the picture data and the chat data so as to be kept in correspondence with each other by using the time, it is possible to view the display of the picture data and the display of the chat data that are kept in correspondence with each other when the viewer wishes to review the contents of a match after the match is finished, for example.

Similarly, when the contents of the display in the picture display region 42a are changed according to an operation performed by the operator, for example, the display controlling unit 56 may change the display in the chat display region 42b in accordance with the change in the display in the picture display region 42a. In that situation, the display controlling unit 56 is capable of causing a piece of chat data corresponding to the image taking time of the scene displayed in the picture display region 42a after the change, to be displayed in the chat display region 42b.

In that situation, the display controlling unit 56 detects the image taking time of the piece of picture data displayed in the picture display region 42a after the change, from the synchronization data storage unit 53. Subsequently, the display controlling unit 56 detects a piece of tag information 79 of the piece of chat data having the most recent processed time earlier than the detected image taking time. After that, the display controlling unit 56 extracts the piece of chat data corresponding to the detected piece of tag information 79, from the chat data storage unit 52. After that, the display controlling unit 56 causes a plurality of pieces of chat data including the extracted piece of chat data to be displayed in the chat display region 42b. In this situation, for example, the extracted piece of chat data is displayed in the bottommost position so as to be the newest piece of chat data in the chat display region 42b. Further, above the piece of chat data, as many pieces of chat data that are displayable in the chat display region 42b and are each chronologically earlier than the one positioned below are displayed. Possible methods for displaying the chat data are not limited to the example described above. It is acceptable to display the chat data by using other methods.

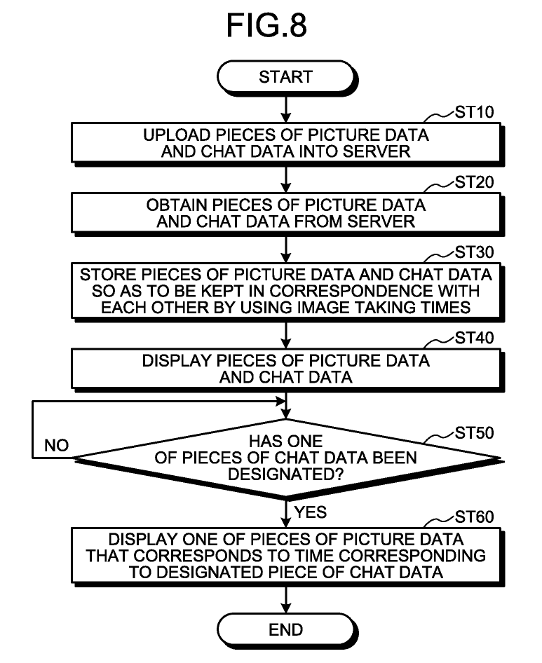

Next, operations performed by the chat system 100 configured as described above will be explained. FIG. 8 is a flowchart illustrating an example of the operations performed by the chat system 100 according to the first embodiment. FIG. 8 illustrates an example of a chat display method according to the first embodiment. As illustrated in FIG. 8, to the server 30, pieces of picture data are input from the camera 10 and pieces of chat data are input by the chat terminal devices 40 and 40A. Further, on the basis of the pieces of picture data, the server 30 generates one or more pieces of chat data. The server 30 saves the pieces of picture data and the pieces of chat data therein so that the chat terminal devices 40, 40A, and so on are able to receive the saved data (step ST10).

When the pieces of picture data and the pieces of chat data have been uploaded in the server 30, in the chat terminal device 40, the data obtainment controlling unit 54 obtains the pieces of picture data and the pieces of chat data from the server 30 (step ST20). At step ST20, the data obtainment controlling unit 54 transmits a signal to ask for permission to download the pieces of picture data and the pieces of chat data, to the server 30 via the communicating unit 43, for example. When having received the signal, the server 30 transmits the pieces of picture data and the pieces of chat data to the chat terminal device 40 after performing a predetermined authentication process and the like.

When the pieces of picture data and the pieces of chat data have been obtained from the server 30, the storage controlling unit 55 stores the obtained pieces of picture data and pieces of chat data into the storage unit 44 so as to be kept in correspondence with each other by using the image taking times and the processed times (step ST30). As a result of step ST30, the synchronization data storage unit 53 stores therein the tag information 79 and the processed time information 80.

Subsequently, on the basis of the pieces of picture data and the pieces of chat data stored in the storage unit 44, the display controlling unit 56 controls the contents of the display displayed on the display unit 42. In this situation, the display controlling unit 56 is able to cause pieces of picture data and pieces of chat data of which the times correspond to each other to be displayed while being in synchronization with each other, in the picture display region 42a and the chat display region 42b of the display unit 42 (step ST40).

After that, the display controlling unit 56 detects whether or not one of the pieces of chat data being displayed in the chat display region 42b has been designated (step ST50). If none of the pieces of chat data has been designated (step ST50: No), the operation at step ST50 is repeatedly performed. By contrast, if one of the pieces of chat data has been designated (step ST50: Yes), the display controlling unit 56 sets a display start time that is based on the processed time of the designated piece of chat data and causes display data from the display start time to be displayed in the picture display region 42a (step ST60). Similarly, the display controlling unit 56 detects whether or not the display in the picture display region 42a has been changed. When the display in the picture display region 42a is changed, the display controlling unit 56 causes a piece of chat data corresponding to the image taking time of the piece of picture data displayed in the picture display region 42a to be displayed in the chat display region 42b.

As explained above, the chat terminal device 40 according to the first embodiment includes: the communicating unit 43 that obtains the pieces of picture data taken of the match of the sporting event and the pieces of chat data indicating the contents of the chat corresponding to the match, from the server 30 into which the pieces of picture data and the pieces of chat data are uploaded; the storage unit 44 storing therein the pieces of picture data and the pieces of chat data obtained by the communicating unit 43 so as to be kept in correspondence with each other by using the image taking times at which the pieces of picture data were taken and the processed times at which the predetermined process was performed on the pieces of chat data; and the controlling unit 45 that arranges the pieces of picture data and the pieces of chat data stored in the storage unit 44 to be displayed in the mutually-different regions of the display unit 42 and, when one of the pieces of chat data displayed on the display unit 42 is designated by using the input unit 41, causes the display unit 42 to display one or more of the pieces of picture data starting from the display start time that is based on the processed time of the designated piece of chat data.

With these arrangements, it is possible to handle the pieces of picture data and the pieces of chat data so as to be kept in correspondence with each other, by using the image taking times and the processed times. Accordingly, for example, it is possible to display pieces of picture data and pieces of chat data of which the image taking times and the processed times correspond to each other, in the picture display region 42a and the chat display region 42b of the display unit 42. Consequently, it is possible to view the display of the picture data and the display of the chat data that are kept in correspondence with each other when the viewer wishes to review the contents of a match in the past, during the match or after the match is finished, for example. In this manner, it is possible to perform the operations while utilizing the temporal correspondence between the pictures and the chat texts of the match of the sporting event.

Further, in the chat terminal device 40 according to the first embodiment, the display controlling unit 56 sets, as the display start time, the time that is earlier, by the first time period P1, than the processed time of the piece of chat data designated by using the input unit 41. With this arrangement, when the designated piece of chat data has contents related to a batting result, it is possible to estimate and set a time at which a series of scenes related to the batting results begins.

Further, in the chat terminal device 40 according to the first embodiment, the display controlling unit 56 sets the first time period P1 in such a manner that the larger the volume of the piece of chat data is, the longer is the first time period P1. With this arrangement, it is possible to set the display start time with a high level of precision, even when it takes a long time to upload the piece of chat data after the batting result is confirmed.

Further, in the chat terminal device 40 according to the first embodiment, the display controlling unit 56 causes the pieces of picture data to be displayed in the picture display region 42a until the second time period P2 elapses since the display start time. With this arrangement, by simply performing the operation to designate one of the pieces of chat data, the operator is able to cause the pieces of picture data to be displayed automatically.

Further, in the chat terminal device 40 according to the first embodiment, the display controlling unit 56 uses, as the processed time, either the upload time at which the piece of chat data was uploaded or the input start time at which the piece of chat data started being input. With this arrangement, it is possible to set the display start time with a high level of precision.

### Second Embodiment

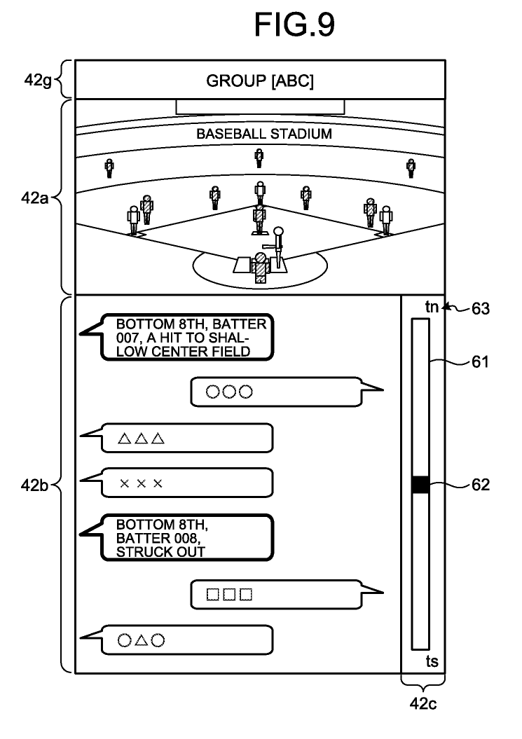

FIG. 9 is a drawing illustrating examples of the input unit 41 and the display unit 42 included in the chat terminal device 40 according to a second embodiment. In the second embodiment, the configuration of the chat system 100 including the chat terminal device 40 is the same as that in the first embodiment. In the second embodiment, display modes of the chat display region 42b are partially different from those in the first embodiment. Accordingly, the second embodiment will be explained while a focus is placed on the difference.

As illustrated in FIG. 9, the display controlling unit 56 may cause a scroll bar 42c to be displayed in the chat display region 42b. The display controlling unit 56 may have the scroll bar 42c displayed constantly or may switch between a display state and a non-display state in response to a predetermined operation such as long-pressing the chat display region 42b, for example. While using time as a reference, the scroll bar 42c is used for scrolling the display of the pieces of chat data in the chat display region 42b. The scroll bar 42c includes a bar main body 61, a slider 62, and a time scale 63.

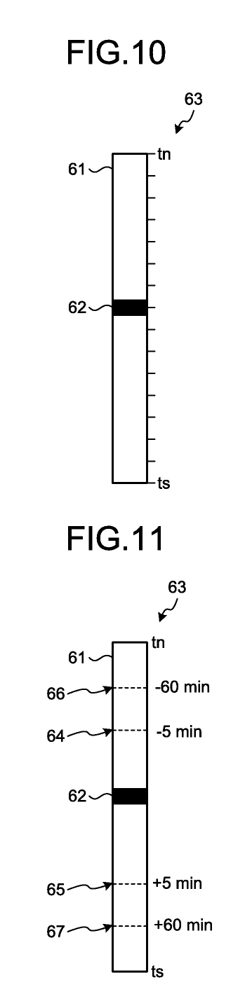

FIG. 10 is a drawing illustrating an example of the scroll bar 42c. As illustrated in FIG. 10, the bar main body 61 indicates a range of the processed times of the pieces of chat data stored in the storage unit 44 with respect to a match of a sporting event. The bar main body 61 indicates the processed times in the range from the earliest processed time (the time ts) to the most recent processed time (tn) with respect to the pieces of chat data stored in the storage unit 44. The bar main body 61 may be belt-shaped, for example, and is displayed so as to extend parallel to the scrolling direction (the lengthwise direction) of the chat display region 42b (a lengthwise display mode). Every time a new piece of chat data is stored into the storage unit 44, the display controlling unit 56 updates the most recent processed time to on the bar main body 61. In that situation, the display controlling unit 56 may change the length (the dimension in the longitudinal direction) of the bar main body 61 or may reduce the scale per unit length without changing the length of the bar main body 61.

The slider 62 indicates the processed time of at least one of the pieces of chat data being displayed in the chat display region 42b. The slider 62 is capable of moving along the bar main body 61 in response to a scrolling operation or the like performed by the operator. In the second embodiment, because the bar main body 61 is in the lengthwise display mode, the slider 62 is capable of moving in the scrolling direction (the lengthwise direction) of the chat display region 42b. With this arrangement, the operator is able to intuitively perform the scrolling operation on the slider 62. Although the slider 62 has a rectangular shape, for example, in the second embodiment, possible embodiments are not limited to this example. The slider 62 may be configured with an arrow or the like, for example.

Alternatively, the bar main body 61 may be displayed so as to extend in the direction (the widthwise direction) perpendicular to the scrolling direction of the chat display region 42b (a widthwise display mode), so that the slider 62 is capable of moving in the widthwise direction. Further, another arrangement is also acceptable in which the extending direction of the bar main body 61 can be switched between the lengthwise direction and the widthwise direction.

For example, when a scrolling operation is performed on the slider 62, the display controlling unit 56 moves the display position of the slider 62 within the range of the bar main body 61, in accordance with the scrolling direction and the scrolling amount. Further, when a scrolling operation is performed on the slider 62, the display controlling unit 56 changes the chat data being displayed in the chat display region 42b, in accordance with the position of the slider 62 within the bar main body 61 that is after the operation.

For example, when the slider 62 is scrolled upward, the display controlling unit 56 causes one or more pieces of chat data that were either uploaded or started being input later than the pieces of chat data that have so far been displayed, to be displayed in the chat display region 42b. By contrast, when the slider 62 is scrolled downward, the display controlling unit 56 causes one or more pieces of chat data that were either uploaded or started being input earlier than the pieces of chat data that have so far been displayed, to be displayed in the chat display region 42b.

When a scrolling operation is directly performed on the chat display region 42b, the display in the chat display region 42b is scrolled on the basis of the number of pieces of chat data. By contrast, when a scrolling operation is performed on the slider 62, the display in the chat display region 42b is scrolled by using time as the reference. Accordingly, for example, when the slider 62 is moved at a constant speed, during a time period having a larger number of pieces of chat data that are either uploaded or started being input per predetermined length of time, the scrolling speed of the chat display region 42b is higher than during a time period having a smaller number of pieces of chat data that are either uploaded or started being input per the predetermined length of time.

Further, in the scroll bar 42c, the display controlling unit 56 may set, with the bar main body 61, a plurality of sections exhibiting mutually-different ratios of change amounts in the processed time, relative to a moving distance of the slider 62. FIG. 11 is a drawing illustrating another example of the scroll bar 42c. As illustrated in FIG. 11, the display controlling unit 56 determines, as a first section, the time period from a time 64 that is five minutes earlier than the time (the current time) at which the slider 62 is positioned, to a time 65 that is five minutes later than the current time. Further, the display controlling unit 56 determines, as a second section, the time period from a time 66 that is 60 minutes earlier than the current time, to the time 64. Further, the display controlling unit 56 determines, as a third section, the time period from the time 65 to a time 67 that is 60 minutes later than the current time. In this configuration, in the bar main body 61, the length of the first section in the lengthwise direction is longer than the length of each of the second and the third sections in the lengthwise direction. Also, the time range of the first section is 10 minutes, whereas the time range of each of the second and the third sections is 55 minutes. Accordingly, when the slider 62 moves through the first section, the change amount in the processed time relative to the moving amount of the slider 62 is smaller than the change amount observed when the slider 62 moves through the second section or the third section.

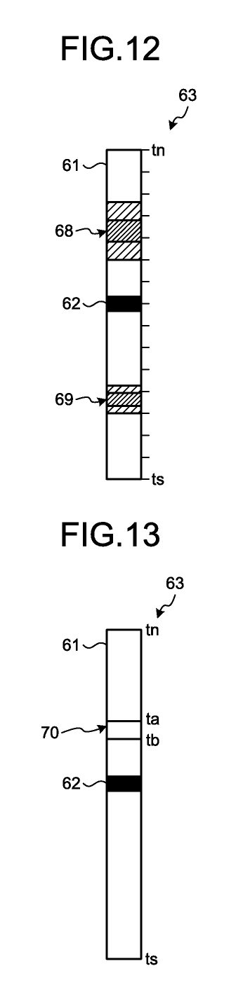

Further, in the scroll bar 42c, the display controlling unit 56 may cause chat density data indicating the quantity of pieces of chat data per predetermined time period (chat density) to be displayed in the bar main body 61. FIG. 12 is a drawing illustrating yet another example of the scroll bar 42c. For instance, when the chat density is larger than a predetermined value, the display controlling unit 56 causes the chat density data to be displayed in the bar main body 61. As illustrated in FIG. 12, the display controlling unit 56 causes pieces of chat density data 68 and 69 to be displayed in the bar main body 61. The pieces of chat density data 68 and 69 may be displayed in such a manner that the degree of darkness becomes higher according to the magnitude of the chat density, for example. Accordingly, in the bar main body 61, the pieces of chat density data 68 and 69 may be displayed with contrast corresponding to the levels of chat density.

Further, the display controlling unit 56 may cause at least one selected from the upload time and the input start time of one of the pieces of chat data being displayed in the chat display region 42b to be displayed in the bar main body 61. FIG. 13 is a drawing illustrating yet another example of the scroll bar 42c. For example, the display controlling unit 56 may cause time processed data of at least one selected from between the upload time and the input start time to be displayed in the bar main body 61, with respect to the piece of chat data having the most recent processed time among the pieces of chat data being displayed in the chat display region 42b. As illustrated in FIG. 13, the display controlling unit 56 causes an input start time to and an upload time tb to be displayed in the bar main body 61. As a result, the operator is able to easily understand the processed times.

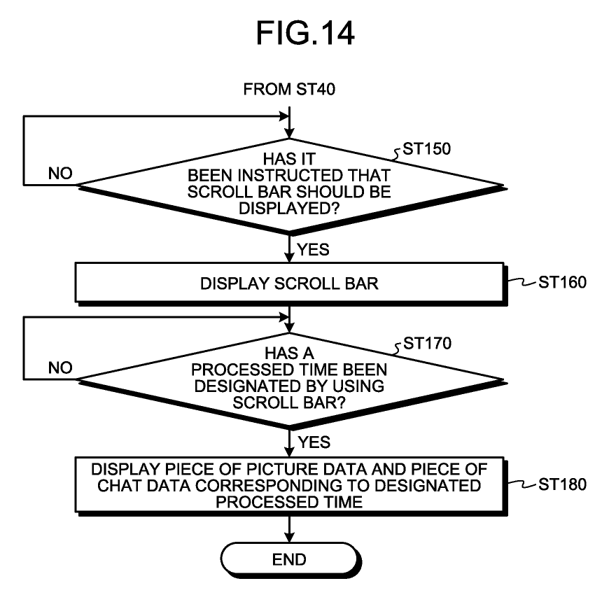

Next, operations performed by the chat system 100 according to the second embodiment will be explained. FIG. 14 is a flowchart illustrating an example of the operations performed by the chat system 100 according to the second embodiment. FIG. 14 illustrates an example of a chat display method according to the second embodiment. In the second embodiment, the chat system 100, at first, performs the same operations as the operations at steps ST10 through ST40 described in the first embodiment.

Subsequently, the display controlling unit 56 detects whether or not an instruction indicating that the scroll bar 42c should be displayed has been input by using the input unit 41 (step ST150). If no such instruction is detected (step ST150: No), the display controlling unit 56 causes the operation at step ST150 to be performed repeatedly. By contrast, if the abovementioned instruction is detected (step ST150: Yes), the display controlling unit 56 arranges the scroll bar 42c to be displayed (step ST160).

After that, the display controlling unit 56 detects whether or not a processed time has been designated by using the scroll bar 42c (step ST170). In other words, at step ST170, the display controlling unit 56 detects whether or not a scrolling operation is performed on the slider 62. If no scrolling operation is detected on the slider 62 (step ST170: No), the display controlling unit 56 causes the operation at step ST170 to be performed repeatedly. By contrast, if a scrolling operation is detected on the slider 62 (step ST170: Yes), the display controlling unit 56 causes a piece of chat data corresponding to the designated processed time to be displayed in the chat display region 42b. In that situation, the display controlling unit 56 may cause a piece of picture data corresponding to the designated processed time to be displayed in the picture display region 42a (step ST180).

As explained above, the chat terminal device 40 according to the second embodiment includes: the communicating unit 43 that obtains the pieces of picture data taken of the match and the pieces of chat data indicating the contents of the chat corresponding to the match, from the server 30 into which the pieces of picture data and the pieces of chat data are uploaded; the storage unit 44 that stores therein the pieces of picture data and the pieces of chat data obtained by the communicating unit 43 so as to be kept in correspondence with each other by using the image taking times at which the piece of picture data were taken and the processed times at which the predetermined process was performed in relation to the pieces of chat data; and the controlling unit 45 that arranges the pieces of picture data and the pieces of chat data stored in the storage unit 44 to be displayed in the mutually-different regions of the display unit 42, further causes the display unit 42 to display the bar main body 61 of the scroll bar 42c indicating the range of the processed times of the pieces of chat data stored in the storage unit 44 and the slider 62 configured to be able to move along the bar main body 61 and indicating the processed time of at least one of the pieces of chat data being displayed on the display unit 42 and, when the position of the slider 62 is changed by using the input unit 41, causes the display unit 42 to display the piece of chat data that corresponds to the processed time corresponding to the position of the slider 62 that is after the change.

With these arrangements, when the position of the slider 62 is changed, the display in the chat display region 42b is changed by using time as the reference. Accordingly, during the time period having a larger number of pieces of chat data that are either uploaded or started being input per the predetermined length of time, it is possible to arrange the scrolling speed of the chat display region 42b to be higher than during the time period having a smaller number of pieces of chat data that are either uploaded or started being input per the predetermined length of time. Consequently, it is possible to perform operations while utilizing, in this manner, the temporal correspondence between the pictures and the chat texts of the match of the sporting event.

Further, in the chat terminal device 40 according to the second embodiment, when the position of the slider 62 is changed by using the input unit 41, the display controlling unit 56 causes the display unit 42 to display the piece of picture data that corresponds to the processed time corresponding to the position of the slider 62 that is after the change in the bar main body 61. With this arrangement, it is possible to handle the pieces of picture data and the pieces of chat data while these pieces of data are kept in correspondence with each other by using the image taking times and the processed times. Consequently, it is possible to display the pieces of picture data and the pieces of chat data of which the image taking times and the processed times correspond with each other, in the picture display region 42a and the chat display region 42b of the display unit 42.

Further, in the chat terminal device 40 according to the second embodiment, the display controlling unit 56 uses, as the processed time, either the upload time at which the piece of chat data is uploaded or the input start time at which the piece of chat data started being input. With this arrangement, it is possible to efficiently change the display of the chat data.

In addition, in the chat terminal device 40 according to the second embodiment, the display controlling unit 56 causes at least one selected from between the upload time and the input start time to be displayed in the bar main body. With this arrangement, the operator is able to easily understand the upload time and the input start time.

Also, in the chat terminal device 40 according to the second embodiment, the display controlling unit 56 sets, with the bar main body 61, the plurality of regions exhibiting the mutually-different ratios of change amounts in the processed time, relative to the moving distance of the slider 62 when the position of the slider 62 is changed. With this arrangement, it is possible to lower the scrolling speed of the chat data in the specific time range. Consequently, it is possible to make it easier to conduct a search in the chat data in the specific time range.

Furthermore, in the chat terminal device 40 according to the second embodiment, the display controlling unit 56 causes the chat density data indicating the quantity of pieces of chat data per the predetermine time period to be displayed in the bar main body 61. With this arrangement, the operator is able to easily understand a time range having higher chat density.

The technical scope of the present invention is not limited to that described in the above embodiments. It is possible to apply a modification thereto as appropriate without departing from the gist of the present invention. For example, with the scroll bar 42c in the second embodiment, another arrangement is acceptable in which scroll arrows are arranged at the top and the bottom of the bar main body 61, so that the slider 62 can be moved step by step, by a predetermined distance in the direction indicated by either one of the scroll arrows, as a result of the operator touching the scroll arrow.

According to at least one aspect of the present invention, it is possible to perform the operations while utilizing the temporal correspondence between the pictures and the chat texts of the match of the sporting event and the like.

What is claimed is:

1. A chat terminal device comprising:
a communicating unit that obtains pieces of picture data taken of a match and pieces of chat data indicating contents of chat corresponding to the match, from a server into which the pieces of picture data and the pieces of chat data are uploaded;
a storage unit that stores therein the pieces of picture data and the pieces of chat data obtained by the communicating unit so as to be kept in correspondence with each other by using image taking times at which the pieces of picture data were taken and processed times at which a predetermined process was performed on the pieces of chat data; and
a control unit that arranges the pieces of picture data and the pieces of chat data stored in the storage unit to be displayed in mutually-different regions of a display unit and that, when one of the pieces of chat data displayed on the display unit is designated by using an input unit, causes the display unit to display one or more of the pieces of picture data starting from a display start time that is based on the processed time of the designated piece of chat data.

2. The chat terminal device according to claim 1, wherein the control unit determines the display start time to be a time that is earlier, by a first time period, than the processed time of the piece of chat data designated by using the input unit.

3. The chat terminal device according to claim 2, wherein the control unit sets the first time period in such a manner that the larger a volume of the piece of chat data is, the longer is the first time period.

4. The chat terminal device according to claim 1, wherein the control unit causes the display unit to display one or more of the pieces of picture data until a second time period elapses since the display start time.

5. The chat terminal device according to claim 1, wherein the control unit uses, as the processed time, either an upload time at which the piece of chat data was uploaded or an input start time at which the piece of chat data started being input.

6. A chat terminal device comprising:
a communicating unit that obtains pieces of picture data taken of a match and pieces of chat data indicating contents of chat corresponding to the match, from a server into which the pieces of picture data and the pieces of chat data are uploaded;
a storage unit that stores therein the pieces of picture data and the pieces of chat data obtained by the communicating unit so as to be kept in correspondence with each other by using image taking times at which the pieces of picture data were taken and processed times at which a predetermined process was performed in relation to the pieces of chat data; and
a control unit that arranges the pieces of picture data and the pieces of chat data stored in the storage unit to be displayed in mutually-different regions of a display unit, causes the display unit to display a bar main body of a scroll bar indicating a range of the processed times of the pieces of chat data stored in the storage unit and a slider configured to be movable along the bar main body and indicating the processed time of at least one of the pieces of chat data being displayed on the display unit, and when a position of the slider is changed by using an input unit, causes the display unit to display such one of the pieces of chat data that corresponds to the processed time corresponding to a position of the slider that is after the change.

7. The chat terminal device according to claim 6, wherein when the position of the slider is changed by using the input unit, the control unit causes the display unit to display such one of the pieces of picture data that corresponds to the processed time corresponding to the position of the slider that is after the change in the bar main body.

8. The chat terminal device according to claim 6, wherein the control unit uses, as the processed time, either an upload time at which the piece of chat data was uploaded or an input start time at which the piece of chat data started being input.

9. The chat terminal device according to claim 8, wherein the control unit causes at least one selected from between the upload time and the input start time to be displayed in the bar main body.

10. The chat terminal device according to claim 6, wherein the control unit sets, with the bar main body, a plurality of regions exhibiting mutually-different ratios of change amounts in the processed time, relative to a moving distance of the slider when the position of the slider is changed.

11. The chat terminal device according to claim 6, wherein the control unit causes chat density data indicating a quantity of pieces of chat data per predetermined time period to be displayed in the bar main body.

12. A chat system comprising:
a server into which pieces of picture data taken of a match and pieces of chat data indicating contents of chat corresponding to the match are uploaded; and
a chat display terminal including a communicating unit that obtains the pieces of picture data and the pieces of chat data from the server, a storage unit that stores therein the pieces of picture data and the pieces of chat data obtained by the communicating unit so as to be kept in correspondence with each other by using image taking times at which the pieces of picture data were taken and processed times at which a predetermined process was performed on the pieces of chat data, and a control unit that arranges the pieces of picture data and the pieces of chat data stored in the storage unit to be displayed in mutually-different regions of a display unit and that, when one of the pieces of chat data displayed on the display unit is designated by using an input unit, causes the display unit to display one or more of the pieces of picture data starting from a display start time that is based on the processed time of the designated piece of chat data.

13. A chat system comprising:
a server into which pieces of picture data taken of a match and pieces of chat data indicating contents of chat corresponding to the match are uploaded; and
a chat display terminal including a communicating unit that obtains the pieces of picture data and the pieces of chat data from the server, a storage unit that stores therein the pieces of picture data and the pieces of chat data obtained by the communicating unit so as to be kept in correspondence with each other by using image taking times at which the pieces of picture data were taken and processed times at which a predetermined process was performed in relation to the pieces of chat data, and a control unit that arranges the pieces of picture data and the pieces of chat data stored in the storage unit to be displayed in mutually-different regions of a display unit, causes the display unit to display a bar main body of a scroll bar indicating a range of the processed times of the pieces of chat data stored in the storage unit and a slider configured to be movable along the bar main body and indicating the processed time of at least one of the pieces of chat data being displayed on the display unit, and when a position of the slider is changed by using an input unit, causes the display unit to display such one of the pieces of chat data that corresponds to the processed time corresponding to a position of the slider that is after the change.

14. A chat display method comprising:
obtaining pieces of picture data taken of a match and pieces of chat data indicating contents of chat corresponding to the match, from a server into which the pieces of picture data and the pieces of chat data are uploaded;
storing, into a storage unit, the obtained pieces of picture data and pieces of chat data so as to be kept in correspondence with each other by using image taking times at which the pieces of picture data were taken and processed times at which a predetermined process was performed on the pieces of chat data; and
arranging the pieces of picture data and the pieces of chat data stored in the storage unit to be displayed in mutually-different regions of a display unit and, when one of the pieces of chat data displayed on the display unit is designated by using an input unit, causing the display unit to display one or more of the pieces of picture data starting from a display start time that is based on the processed time of the designated piece of chat data.

15. A chat display method comprising:
obtaining pieces of picture data taken of a match and pieces of chat data indicating contents of chat corresponding to the match, from a server into which the pieces of picture data and the pieces of chat data are uploaded;
storing, into a storage unit, the obtained pieces of picture data and pieces of chat data so as to be kept in correspondence with each other by using image taking times at which the pieces of picture data were taken and processed times at which a predetermined process was performed in relation to the pieces of chat data; and
arranging the pieces of picture data and the pieces of chat data stored in the storage unit to be displayed in mutually-different regions of a display unit, causing the display unit to display a bar main body of a scroll bar indicating a range of the processed times of the pieces of chat data stored in the storage unit and a slider configured to be movable along the bar main body and indicating the processed time of at least one of the pieces of chat data being displayed on the display unit, and when a position of the slider is changed by using an input unit, causing the display unit to display such one of the pieces of chat data that corresponds to the processed time corresponding to a position of the slider that is after the change.

16. A recording medium having recorded thereon a chat display computer program that causes a computer to execute processes of:
obtaining pieces of picture data taken of a match and pieces of chat data indicating contents of chat corresponding to the match, from a server into which the pieces of picture data and the pieces of chat data are uploaded;
storing, into a storage unit, the obtained pieces of picture data and pieces of chat data so as to be kept in correspondence with each other by using image taking times at which the pieces of picture data were taken and processed times at which a predetermined process was performed on the pieces of chat data; and
arranging the pieces of picture data and the pieces of chat data stored in the storage unit to be displayed in mutually-different regions of a display unit and, when one of the pieces of chat data displayed on the display unit is designated by using an input unit, causing the display unit to display one or more of the pieces of picture data starting from a display start time that is based on the processed time of the designated piece of chat data.

17. A recording medium having recorded thereon a chat display computer program that causes a computer to execute processes of:
obtaining pieces of picture data taken of a match and pieces of chat data indicating contents of chat corresponding to the match, from a server into which the pieces of picture data and the pieces of chat data are uploaded;
storing, into a storage unit, the obtained pieces of picture data and pieces of chat data so as to be kept in correspondence with each other by using image taking times at which the pieces of picture data were taken and processed times at which a predetermined process was performed in relation to the pieces of chat data; and
arranging the pieces of picture data and the pieces of chat data stored in the storage unit to be displayed in mutually-different regions of a display unit, causing the display unit to display a bar main body of a scroll bar indicating a range of the processed times of the pieces of chat data stored in the storage unit and a slider configured to be movable along the bar main body and indicating the processed time of at least one of the pieces of chat data being displayed on the display unit, and when a position of the slider is changed by using an input unit, causing the display unit to display such one of the pieces of chat data that corresponds to the processed time corresponding to a position of the slider that is after the change.
